(19) United States
(12) Patent Application Publication
(10) Pub. No.: US 2005/0027598 A1
(43) Pub. Date: Feb. 3, 2005

(54) Cooperative advertising media and meal plan

(76) Inventor: Judith S. Greiner, Grosse Pointe Farms, MI (US)

Correspondence Address: Christopher J. Fildes;Fildes & Outland, P.C., Suite 2, 20916 Mack Avenue, Grosse Pointe Woods, MI, 48236, US

(21) Appl. No.: 10/894,777

(22) Filed: Jul. 20, 2004

Related U.S. Application Data
(60) Provisional application No. 60/491,394, filed on Jul. 31, 2003.

(51) Int. Cl. G06F 17/60

(52) U.S. Cl. 705/14

(57) ABSTRACT

Cooperative advertising media and meal plan apparatus and method disclosed include a two sided promotional vehicle having first and second sides, a recipe portion and more than one detachable multi-brand coupon portions adjacent said recipe portion, graphics on one side of the recipe portion illustrating a completed recipe, indicia on the other side of the recipe portion describing recipe ingredients and preparation instructions, and the detachable multi-brand coupon portions correspond to ingredients featured in said recipe portion.

### CROSS REFERENCE TO RELATED APPLICATION

This application claims the priority of U.S. Provisional Application No. 60/491,394 filed Jul. 31, 2003.

### TECHNICAL FIELD

This invention relates to a cooperative advertising media and meal plan apparatus and method for use including a plurality of detachable coupons corresponding to a recipe or meal plan featured in the advertising media.

### BACKGROUND OF THE INVENTION

It is known in the art relating to coupon advertising for consumer packaged goods manufacturers (CPG's) to offer discounts on food items. CPG's use coupons to increase product sales, encourage trial of new products, promote brand switching, and reward loyal customers. Consumers benefit from coupons through the cost savings realized on their purchases.

Coupons are delivered into the hands of the consumer through a variety of methods including direct mail, in/on package, newspapers, magazines, and electronic (internet) programs. Cooperative free-standing inserts (FSIs), multi-page booklets filled with coupon advertisements, account for over 80% of all coupons distributed. Individual pages, or portions thereof, are purchased by CPG manufacturers on which to place coupon advertisements for their respective brands. FSIs are delivered to approximately 60 million homes through Sunday newspaper supplement programs. The overwhelming popularity of FSIs is a result of its cooperative nature: the costs of print manufacturing and distribution are shared by advertisers while consumers are drawn to the large collection of coupons offered in a single organized format.

The consumer realizes that in an ideal world, they would clip coupons, review grocery store sale circulars, and peruse cookbooks before preparing a weekly meal plan. However, consumers in today's society are living at a harried pace. Whereas they are interested in saving money, time is a precious commodity. Many consumers view the potential savings as being outweighed by the time-consuming and tedious practices of clipping, filing, and storing coupons.

Recipes are a common element used in food promotions. By offering an appealing meal plan with the featured brand listed as an ingredient, the CPG attempts to create a “need” or “call to action” for the purchase of their product. Coupon savings incorporated into the same advertisement provides additional purchase appeal. Recipes that are easy to prepare and quick to serve are especially popular. Unfortunately, the consumer must often make a choice between clipping a recipe or maintaining the integrity of the information on the reverse side of the page. In addition, the variety of presentation formats makes it difficult for the consumer to organize recipes for future use in meal planning.

While manufacturers enjoy the savings and advertising value of cooperative coupon distribution vehicles, traditional single brand promotions have limited effectiveness in motivating the consumer to purchase featured brands to be included in their meal plans. Some large manufacturers try to feature several of their various brands in corporate advertisements. While these policies are cost-effective, the individual brand manager is limited in his/her ability to market their respective products until a corporate program is implemented.

Despite the concerted efforts of the promotion industry to reach consumers with billions of money-saving coupon offers each year, less than 2% of coupons are ever redeemed. These low redemption rates are an indication that coupons must become more user-friendly.

There is a need to enhance consumer motivation to purchase products, save the consumer time and money, and provide cooperative advertising opportunities for CPG manufacturers.

### SUMMARY OF THE INVENTION

The present invention provides a cooperative advertising media and meal plan apparatus in which multiple manufacturers cooperatively advertise by displaying their multiple brand coupons for various ingredients found in a recipe or meal plan. Accordingly, consumers are more motivated to purchase the required ingredients for a given recipe and realize increased cost savings over single brand advertising media. Additionally, such cooperative advertising media provides advertising cost savings to the manufacturers who share advertising costs with one another.

Additional features and advantages of the invention follow.

Cooperative Cost Savings for CPG's

Participation in this invention is based on brand/ingredients. Ad space is sold by coupon, with a limit of one brand/ingredient represented per coupon. This allows individual brand managers to participate in full page, two-sided promotions, paying only a fraction of the total cost.

Because recipe development, photography, and ad design costs are also shared by the participating brands, participation in the program may be offered at a fixed rate, allowing facilitated promotion budgeting for participants.

Time Savings for Consumers

Individual coupons are traditionally detached from their corresponding advertisements. Once separated, the coupon must be placed into some sort of filing system so it can be referenced/located. Various filing/storage formats are available, but are tedious and time consuming to manage.

The nature of the invention does not require filing of the coupons; coupons are already organized and attached to a corresponding recipe. The ad may be taken to the store in its entirety, with the coupons being left attached until the moment of store redemption and with the recipe acting as a shopping list for the meal plan.

Improved Cooperative Ad Format

The two-sided format of the invention guarantees that the integrity of coupons and recipes will not be destroyed when elements of the promotion are separated for redemption.

Ad Flexibility

Although a meal plan is suggested by the recipe, the consumer has the choice to utilize the coupons individually and independent of the featured recipe if desired.

More specifically, a cooperative advertising media and meal plan apparatus includes a two sided promotional vehicle such as a paper sheet or other printable medium having first and second sides having a recipe portion and more than one detachable multi-brand coupon portions adjacent the recipe portion. Graphics on one side of the recipe portion illustrate a completed recipe. Indicia on the other side of the recipe portion describe recipe ingredients and preparation instructions. The detachable multi-brand coupon portions correspond to ingredients featured in the recipe portion.

The recipe portion may be of a standardized filing size, such as 5″×8″ note-card format or other known size, so that it can be cut out of the promotional vehicle and filed away for future reference.

The graphics on one side of the recipe portion may be a picture or other illustration of the completed recipe or meal shown.

The recipe portion and multi-brand coupon portions are preferably delineated for easy cutting or other separation such as by perforation.

A method of cooperative advertising and meal planning includes the steps of:
providing a two sided promotional vehicle including a recipe portion and more than one adjacent, detachable multi-brand coupon portions;
providing graphics displaying a completed recipe on one side of the recipe portion; and
providing indicia describing recipe ingredients and preparation instructions on the other side of the recipe portion.

Furthermore, the detachable multi-brand coupon portions correspond to ingredients featured in said recipe.

Accordingly, the cooperative advertising format provided by the two sided promotional vehicle is a powerful call to action for the consumer as he/she is provided with a plurality of cost saving coupons, simple to manufacture and use, and protective of the integrity of the coupons and recipe.

These and other features and advantages of the invention will be more fully understood from the following detailed description of the invention taken together with the accompanying drawings.

### BRIEF DESCRIPTION OF THE DRAWINGS

In the drawings:

FIG. 1 is a plan view of a first side of a two sided promotional vehicle constructed in accordance with the invention illustrating a recipe portion including graphics displaying a completed recipe thereon and adjacent detachable coupon portions; and

FIG. 2 is a plan view a second side of the two sided promotional vehicle illustrating indicia on the recipe portion listing ingredients and preparation instructions for the displayed recipe illustrated on the other side.

### DETAILED DESCRIPTION OF THE INVENTION

Referring now to the drawings in detail, numeral 10 generally indicates a cooperative advertising media and meal plan in accordance with the present invention. The cooperative advertising media and meal plan 10 enhances consumer motivation to purchase products, saves consumers time and money, and provides cooperative advertising opportunities for CPG manufacturers.

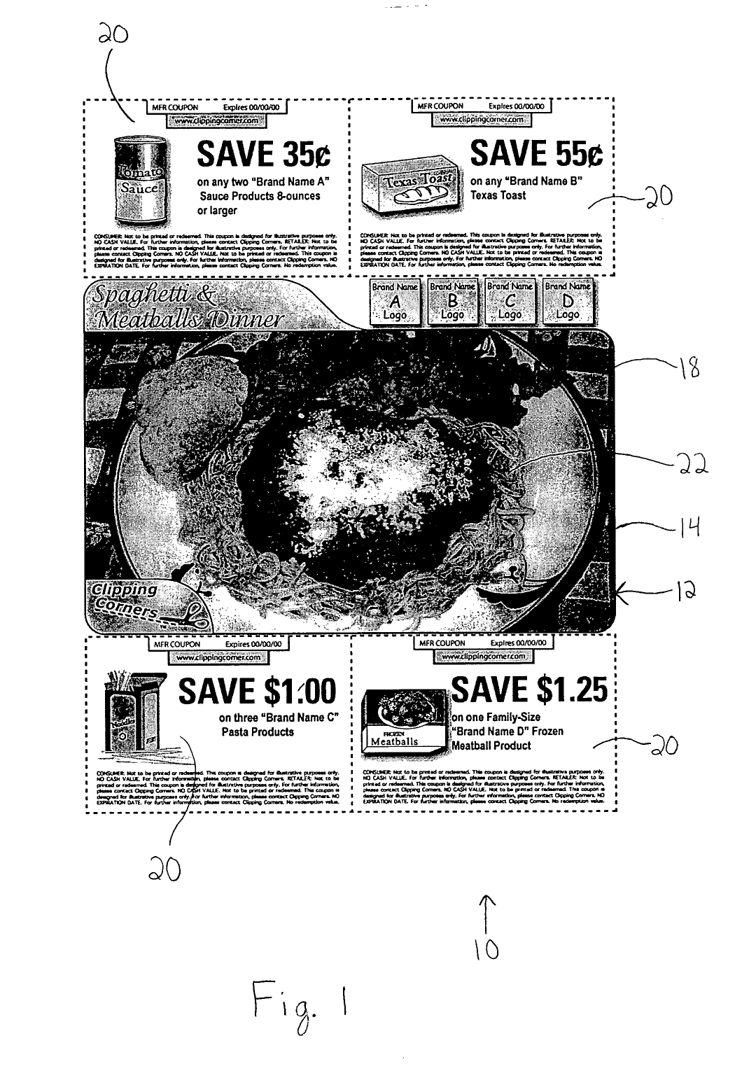

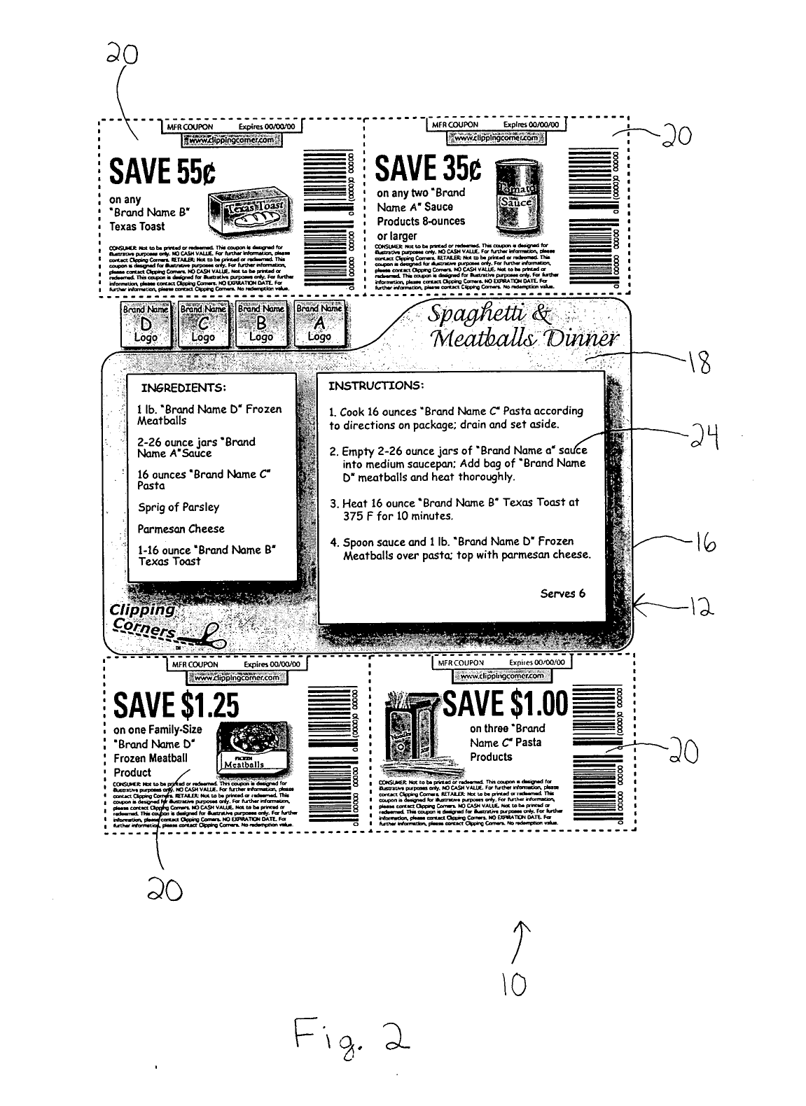

With reference to FIGS. 1 and 2, a cooperative advertising media and meal plan 10 includes a two sided promotional vehicle 12 such as a paper sheet or other printable medium having a first side 14 and a second side 16. The promotional vehicle 12 further includes a recipe portion 18 and more than one detachable multi-brand coupon portions 20 adjacent the recipe portion 18. Graphics 22 on one side 14 of the recipe portion 18 illustrate a completed recipe. Indicia 24 on the other side 16 of the recipe portion 18 describe recipe ingredients and preparation instructions. The detachable multi-brand coupon portions 20 correspond to ingredients featured in the recipe portion 18. The term multi-brand means more than one product brand, wherein a product brand is a source designation for the goods in the trademark sense. The multi-brands may ultimately be manufactured and sold by a single business entity or more than one business entity.

In one embodiment, the recipe portion 18 may be of a standardized filing size, such as, for example, a 5″×8″ note-card format or other known size, so that it can be cut out of the promotional vehicle and filed away for future reference. The graphics 22 on one side 14 of the recipe portion 18 may be a picture, for example, a picture of the meal prepared according to the recipe described by the indicia 24 on the other side 16 of the recipe portion. The recipe portion 18 and the multi-brand coupon portions 20 may be delineated. This aids a user of the cooperative advertising media and meal plan 10 in separating coupon portions 20 from the recipe portion 18.

A method of cooperative advertising and meal planning includes the steps of:
providing a two sided promotional vehicle 12 including a recipe portion 18 and more than one adjacent, detachable multi-brand coupon portions 20;
providing graphics 22 displaying a completed recipe on one side 14 of the recipe portion 18; and
providing indicia 24 describing recipe ingredients and preparation instructions on the other side 16 of the recipe portion 18.

In a specific embodiment of the method, the detachable multi-brand coupon portions 20 may correspond to ingredients featured in the recipe. This usefully provides a “call to action” for the purchase of the product ingredients listed in the recipe to be included in the meal plan and motivates consumers to purchase the brands featured in the coupon portions 20.

A consumer may make use of a cooperative advertising media and meal plan 10 according to the present invention in the following manner. A consumer may view the recipe portion 18 and decide that he/she would like to prepare the meal shown by the graphics 22 and described by the indicia 24. The consumer may then take the entire promotional vehicle 12 of the cooperative advertising 10 to a store. At the store, the consumer may then use the coupons of the coupon portions 20 to purchase the products that are advertised both in the recipe portion 18 and the coupon portions 20. The products advertised in the coupon portions 20 correspond to ingredients in the recipe of the recipe portion 18. Hence, the consumer conveniently knows which products to purchase in order to have the ingredients for the recipe and the consumer has the coupons for these ingredients readily available. To use the coupons of the coupon portions 20, the consumer may separate the coupon portions 20 from the recipe portion 18 at or prior to the checkout counter. After removing the coupon portions 20, the consumer may take the remaining recipe portion 18 back home to use in preparing the recipe. Since the recipe portion 18 may be of a standardized filing size, the consumer may easily store the recipe portion 18 for further future use. The fact that the recipe portion 18 is easily storable also provides CPG's with continued advertising because their products are listed in the recipe portion.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

1. Cooperative advertising media and meal plan apparatus comprising:
a two sided promotional vehicle having first and second sides;
said promotional vehicle including a recipe portion and more than one detachable multi-brand coupon portions adjacent said recipe portion;
graphics on one side of said recipe portion illustrating a completed recipe;
indicia on the other side of said recipe portion describing recipe ingredients and preparation instructions; and
said detachable multi-brand coupon portions corresponding to ingredients featured in said recipe portion.

2. Cooperative advertising media and meal plan apparatus as in claim 1, wherein said two sided promotional vehicle is a paper sheet.

3. Cooperative advertising media and meal plan apparatus as in claim 1, wherein said recipe portion is of a standardized filing size.

4. Cooperative advertising media and meal plan apparatus as in claim 1, wherein said graphics on one side of said recipe portion is a picture.

5. Cooperative advertising media and meal plan apparatus as in claim 1, wherein said recipe portion and said multi-brand coupon portions are delineated.

6. A method of cooperative advertising and meal planning comprises the steps of:
providing a two sided promotional vehicle including a recipe portion and more than one adjacent, detachable multi-brand coupon portions;
providing graphics displaying a completed recipe on one side of said recipe portion; and
providing indicia describing recipe ingredients and preparation instructions on the other side of said recipe portion.

7. A method of cooperative advertising and meal planning as in claim 6, wherein said detachable multi-brand coupon portions correspond to ingredients featured in said recipe.
